(19) United States
(12) Patent Application Publication
(10) Pub. No.: US 2026/0362362 A1
(43) Pub. Date: Nov. 12, 2026

(54) Communication Method and Communication Device for Handling Insufficient Network Supportability

(71) Applicant: MEDIATEK INC., Hsin-Chu (TW)

(72) Inventor: Yuan-Chieh Lin, Hsinchu City (TW)

(73) Assignee: MEDIATEK INC., Hsin-Chu (TW)

(21) Appl. No.: 19/475,061

(22) PCT Filed: Aug. 20, 2024
(86) PCT No.: PCT/CN2024/113282

§ 371 Date: Oct. 14, 2025

Related U.S. Application Data
(60) Provisional application No. 63/520,666, filed on Aug. 21, 2023.

(51) Int. Cl. H04W 60/04; H04L 5/00; H04W 48/18; H04W 84/04

(52) U.S. Cl. CPC H04W 60/04; H04L 5/0053; H04W 48/18; H04W 84/042

(57) ABSTRACT

A communication method for handling insufficient network supportability in a user equipment (UE) is disclosed. The UE has selected a first public land mobile network (PLMN) and initiates a registration procedure with the first PLMN. The method includes receiving an acknowledgement message corresponding to the registration procedure from the first PLMN; and in response to the acknowledgement message indicating that the first PLMN does not support a service required by the UE, performing a PLMN selection procedure with the first PLMN considered as a lowest priority after completion of the registration procedure.

### CROSS REFERENCE TO RELATED APPLICATION

This application claims the benefit of U.S. Provisional Application No. 63/520,666, filed on Aug. 21, 2023. The content of the application is incorporated herein by reference.

### BACKGROUND OF THE INVENTION

### 1. Field of the Invention

The present invention relates to a communication method and a communication device used in a wireless communication system, and more particularly, to a communication method and a communication device for handling insufficient network supportability.

### 2. Description of the Prior Art

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. The Next Generation Mobile Network (NGMN) board has decided to focus the future NGMN activities on defining the end-to-end requirements for 5G new radio (NR) systems.

The 5G system is the mobile network generation that is currently being launched across the globe. It is often regarded as a key technology for the future of digital societies. Compared with previous generations, the 5G system no longer focuses on the classical use case of mobile telephony. Instead, its main goals are to provide gigabit data rates for end devices (Enhanced Mobile Broadband (eMBB)), to connect the increasing number of smart things (Massive Machine Type Communications (mMTC)), and to provide guaranteed service properties for time-critical applications (ultra-reliable low-latency communication (URLLC)).

Since the 5G system is pivotal for digital mobile societies, Mobile Network Operators (MNOs) are expected to transition from 4G to 5G Stand-Alone (SA) networks. However, during this transition, 5G Non-Stand-Alone (NSA) networks are widely used. SA is a fully independent 5G deployment, utilizing both the 5G Radio Access Network (RAN) and the 5G core network, which allows for advanced features like network slicing and improved support for IoT devices. On the other hand, NSA builds upon existing 4G LTE infrastructure, using the 4G core network for essential functions while adding the 5G RAN, which can help MNOs to swiftly move from 4G to 5G while reusing the current 4G facilities.

NSA provides a transitional step from 4G towards 5G. However, according to the current 3GPP technical specifications, UE may not be efficiently served for some 5G services under the 5G NSA networks, such as non-Internet Protocol (non-IP), Ethernet, or Unmanned Aerial Systems (UAS) services.

Therefore, a solution is sought.

### SUMMARY OF THE INVENTION

Therefore, the present invention is to provide a communication method and a communication device to improve the drawbacks of the prior art.

An embodiment of the present invention discloses a communication method for handling insufficient network supportability in a user equipment (UE), wherein the UE has selected a first public land mobile network (PLMN) and initiates a registration procedure with the first PLMN. The method comprises receiving an acknowledgement message corresponding to the registration procedure from the first PLMN; and in response to the acknowledgement message indicating that the first PLMN does not support a service required by the UE, performing a PLMN selection procedure with the first PLMN considered as a lowest priority after completion of the registration procedure.

Another embodiment of the present invention discloses a communication device for handling insufficient network supportability, wherein the communication device has selected a first public land mobile network (PLMN) and initiates a registration procedure with the first PLMN. The communication device comprises a storage device; and a processing circuit, coupled to the storage device, wherein the processing circuit receives an acknowledgement message corresponding to the registration procedure from the first PLMN; and in response to the acknowledgement message indicating that the first PLMN does not support a service required by the communication device, performs a PLMN selection procedure with the first PLMN considered as a lowest priority after completion of the registration procedure.

Another embodiment of the present invention discloses a communication method for handling insufficient network supportability in a user equipment (UE), wherein the UE has selected a first public land mobile network (PLMN) and initiates a registration procedure with the first PLMN. The method comprises receiving an acknowledgement message corresponding to the registration procedure from the first PLMN; and in response to the acknowledgement message indicating that the first PLMN does not support a service required by the UE, performing a PLMN selection procedure with the first PLMN determined as a lowest priority after completion of the registration procedure.

Another embodiment of the present invention discloses a communication device for handling insufficient network supportability, wherein the communication device has selected a first public land mobile network (PLMN) and initiates a registration procedure with the first PLMN. The communication device comprises a storage device; and a processing circuit, coupled to the storage device, wherein the processing circuit receives an acknowledgement message corresponding to the registration procedure from the first PLMN; and in response to the acknowledgement message indicating that the first PLMN does not support a service required by the communication device, performs a PLMN selection procedure with the first PLMN determined as a lowest priority after completion of the registration procedure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system.

FIG. 2 is a schematic diagram of a communication device according to an example of the present invention.

FIG. 3 is a flowchart of a process according to an example of the present invention.

FIG. 4 and FIG. 5 are schematic diagrams of scenarios for handling insufficient network supportability according to examples of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. “Approximately” means that within the acceptable error range, a person with ordinary knowledge in the field can solve the technical problem within a certain error range and basically achieve the technical effect. Also, the term “couple” is intended to mean either an indirect or direct, wired or wireless electrical connection.

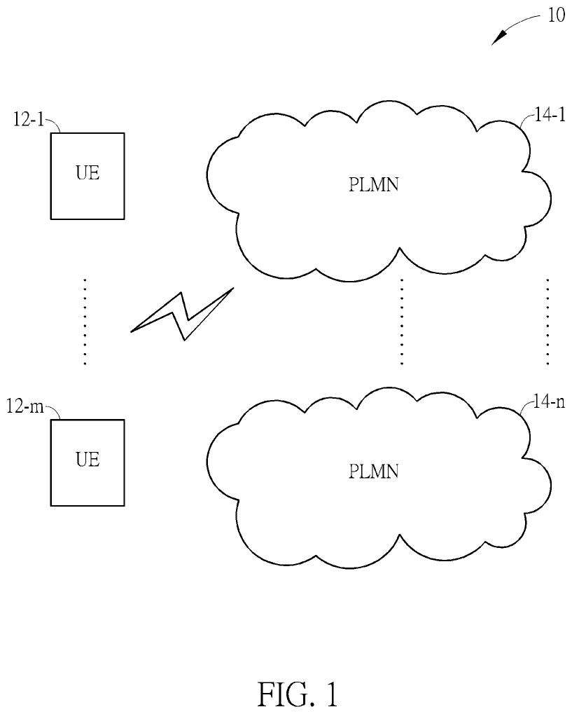

Please refer to FIG. 1. FIG. 1 is a schematic diagram of a wireless communication system 10. The wireless communication system 10 is briefly composed of a plurality of user equipments (UEs) 12_1 to 12_m and a plurality of public land mobile networks (PLMNs) 14_1 to 14_n. Each of the UEs 12_1 to 12_m may be a low cost device (e.g., machine type communication (MTC) device), a device-to-device (D2D) communication device, a narrow-band internet of things (IoT) (NB-IoT), a mobile phone, a laptop, a tablet computer, an electronic book, a portable computer system, or combination thereof. Each of the PLMNs 14_1 to 14_n represents a network that provides various wireless communication services within a specific country, operated by a particular MNO. A PLMN may support one or multiple cellular technologies such as UMTS/3G, LTE/4G, and NR/5G. To provide 5G services while reusing the current 4G facilities, one or more of the PLMNs 14_1 to 14_n may support the NSA version of 5G technology, which is built upon existing 4G LTE infrastructure, using the 4G core network, known as Evolved Packet Core (EPC), for essential functions while adding the 5G RAN.

As well known in the art, the 5G RAN consists of two types of base stations (BSs): eNBs and gNBs. The eNBs (master nodes) are LTE BSs that are used to exchange control plane and data plane messages with the UE. In a 5G NSA architecture, the eNB performs functions like paging, over-the-air security, and handovers. The gNBs (secondary nodes), also referred to as “en-gNB” or “SgNB,” serve as 5G base stations dedicated to exchanging data plane messages and work in conjunction with the eNBs, primarily to significantly enhance the data rate for the UEs. The main components of the 4G core network comprise Mobility Management Entity (MME), Home Subscriber Service (HSS), Serving Gateway (S-GW) and Packet Data Network (PDN) Gateway (P-GW). The MME is the central control node, which is responsible for authenticating and allocating resources to the UEs when they connect to the network. The HSS is a database that stores user-related data such as International Mobile Subscriber Identities (IMSIs), shared keys, and subscription data. The S-GW is responsible for routing and forwarding user data packets. The P-GW serves as a point of interconnection between the core network and the external networks (i.e., the Internet and other mobile networks).

NSA provides a transitional step from 4G towards 5G, such that UE may experience 5G applications under the 4G LTE infrastructure, e.g. extended Protocol Configuration Options.

In the realm of mobile communications, Protocol Configuration Options (PCO) in 4G networks play a pivotal role in the customization and optimization of network connections for UEs. These options allow for the dynamic adjustment of network settings, such as IP address allocation, Domain Name System (DNS) server addresses, and Quality of Service (QoS) parameters. The flexibility of PCO ensures that devices can efficiently communicate with the network, adapting to varying conditions and user requirements.

Transitioning to 5G, the extended Protocol Configuration Options (ePCO) extend this functionality further, providing even more granular control over the network configuration. The ePCO enables the support of advanced features like slicing, where a single physical network can be partitioned into multiple virtual networks, each tailored to specific service requirements. This is crucial for 5G's promise of supporting a wide array of applications, from high-speed mobile broadband to mission-critical communication systems.

With the ePCO, the UE may be served for non-IP/Ethernet/UAS services. However, according to the current 3GPP technical specifications, UE may not efficiently initiate these 5G services.

Specifically, if the UE supports ePCO, it must signal this support in the ATTACH request message during an ATTACH procedure, which is a process where the UE registers with the PLMN (especially, MME) to establish an EPS Bearer, allowing it to send and receive data. If the MME of the PLMN supports ePCO and receives an indication of ePCO support from the UE (via the ATTACH request message), the MME shall acknowledge this support in the ATTACH accept message (which is fed back to the UE). Additionally, if the UE establishes a PDN connection to non-IP or Ethernet Access Point Name (APN), or for UAS services, the UE is required to support ePCO. When the UE supporting ePCO attempts to use non-IP/Ethernet/UAS APN but the MME does not support ePCO, the UE knows the MME does not support ePCO upon receiving the ATTACH accept message. However, the current 3GPP technical specifications do not detail the subsequent actions for the UE in such cases, which would potentially lead to a situation where the UE remains connected to the PLMN not supporting ePCO and is unable to receive services for non-IP, Ethernet, or UAS connections.

In short, the UE and the MME may receive indications of ePCO support from each other via the ATTACH request message and the ATTACH accept message in the ATTACH procedure, and the indications of ePCO support do not directly affect the outcome of the ATTACH procedure. However, the current 3GPP technical specifications do not detail the actions for the situation where the UE supporting ePCO attempts to use non-IP/Ethernet/UAS APN but the MME of the PLMN selected by the UE does not support ePCO, causing the UE to stay in the PLMN without being served for non-IP, Ethernet, or UAS services.

In another example, the UE may register with an MME and move to an area served by a new MME of the same PLMN, where the original MME may support ePCO but the new MME does not support ePCO. The UE may initiate a Tracking Area Updating (TAU) procedure to inform the new MME of its new location. The UE can know whether the new MME supports ePCO through a TAU ACCEPT message in the TAU procedure. However, the abovementioned deficiency would happen, i.e. the current 3GPP technical specifications do not detail the actions for the situation where the UE supporting ePCO attempts to use non-IP/Ethernet/UAS APN but the (latest) MME of the PLMN serving the UE does not support ePCO, causing the UE to stay in the PLMN without being served for non-IP, Ethernet, or UAS services.

To cure the deficiency of the current 3GPP technical specifications, the present invention provides methods for the UE to accurately perform PLMN selection when the PLMN serving the UE does not support UE-required services.

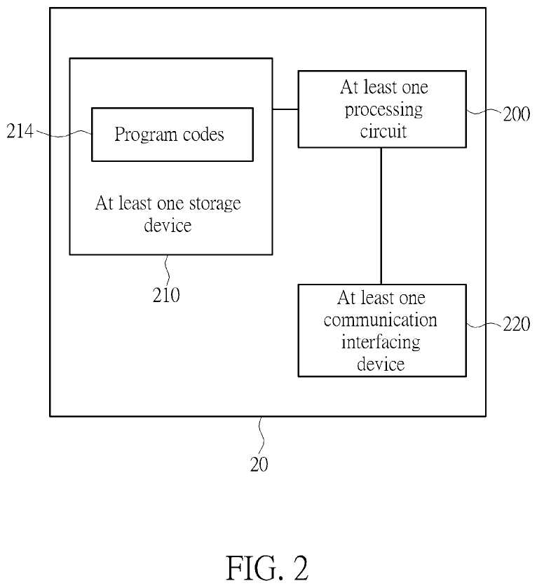

Please refer to FIG. 2, which is a schematic diagram of a communication device 20 according to an example of the present invention. The communication device 20 may be any of the UEs 12_1 to 12_m shown in FIG. 1, but is not limited herein. The communication device 20 may include at least one processing circuit 200 such as a microprocessor or Application Specific Integrated Circuit (ASIC), at least one storage device 210 and at least one communication interfacing device 220. The at least one storage device 210 may be any data storage device that may execute processes or store program codes 214, accessed and executed by the at least one processing circuit 200. Examples of the at least one storage device 210 include, but are not limited to, a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), hard disk, optical data storage device, non-volatile storage device, non-transitory computer-readable medium (e.g., tangible media), etc. The at least one communication interfacing device 220 is preferably at least one transceiver and is used to transmit and receive signals (e.g., data, messages and/or packets) according to processing results of the at least one processing circuit 200.

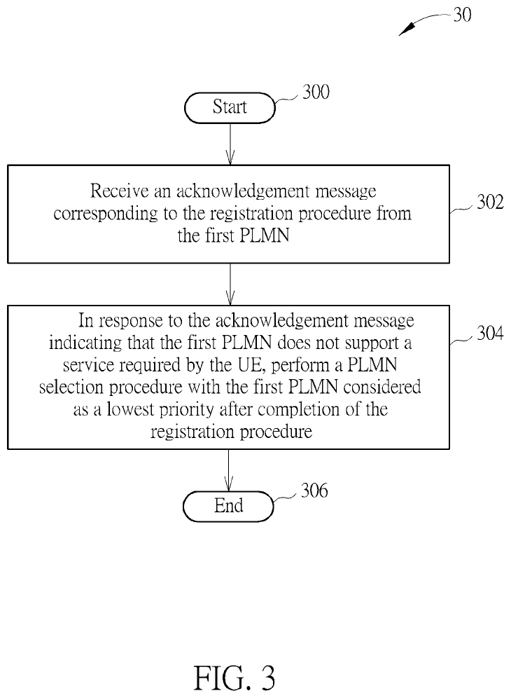

FIG. 3 is a flowchart of a process 30 according to an example of the present invention. The process 30 may be utilized in a UE (e.g., any of the UEs 12_1 to 12_m in FIG. 1, or the communication device 20 in FIG. 2), which has selected a first PLMN and initiates a registration procedure with the first PLMN. The process 30 may handle insufficient network supportability, i.e., the issue that the first PLMN does not support a service required by the UE. For example, the UE may support ePCO in a 5G NSA network, and the service required by the UE may be non-IP, Ethernet PDN type, or UAS service, while the first PLMN does not support ePCO. The process 30 may be compiled into the program codes 214 stored in the at least one storage device 210 and/or executed by the at least one processing circuit 200 shown in FIG. 2 and includes the following steps:

Step 300: Start.

Step 302: Receive an acknowledgement (e.g., Accept) message corresponding to the registration procedure from the first PLMN.

Step 304: In response to the acknowledgement message indicating that the first PLMN does not support a service required by the UE, perform a PLMN selection procedure with the first PLMN considered as a lowest priority after completion of the registration procedure.

Step 306: End.

According to the process 30, after the UE selects a first PLMN and initiates a registration procedure with the first PLMN, if an acknowledgement message corresponding to the registration procedure received from the first PLMN (Step 302) indicates that the first PLMN does not support a service required by the UE, the UE may perform a PLMN selection procedure with the first PLMN considered as a lowest priority after completion of the registration procedure (Step 304). Since the first PLMN is considered as the lowest priority, the UE may not select the first PLMN in the PLMN selection procedure, and may select a second PLMN which may support the service required by the UE. Thus, the UE may be served for the required service by the second PLMN. Without considering “the first PLMN as the lowest priority” PLMN selection candidate, based on the traditional PLMN selection, the Registered PLMN (the first PLMN to which the UE has successfully registered), is the highest priority PLMN selection candidate during the traditional PLMN selection procedure.

In an example, the UE supports ePCO in a 5G NSA network, and the service required by the UE is one or more of non-IP, Ethernet PDN type, and UAS services, while the first PLMN does not support ePCO. In such a situation, the registration procedure may be an ATTACH procedure, and the acknowledgement message may be an ATTACH accept message of the ATTACH procedure. Since the first PLMN does not support ePCO, an ePCO bit in an Evolved Packet System (EPS) network feature support Information Element (IE) in the ATTACH accept message is not set to “extended protocol configuration options supported.” Therefore, after the UE receives the ATTACH accept message from the first PLMN, the UE knows that the first PLMN does not support ePCO and cannot provide the service required by the UE, such that the UE performs a PLMN selection procedure with the first PLMN considered as the lowest priority after completion of the ATTACH procedure according to the process 30. As a result, the UE would not stay in the first PLMN after the PLMN selection procedure, and may select a second PLMN which may support the service required by the UE.

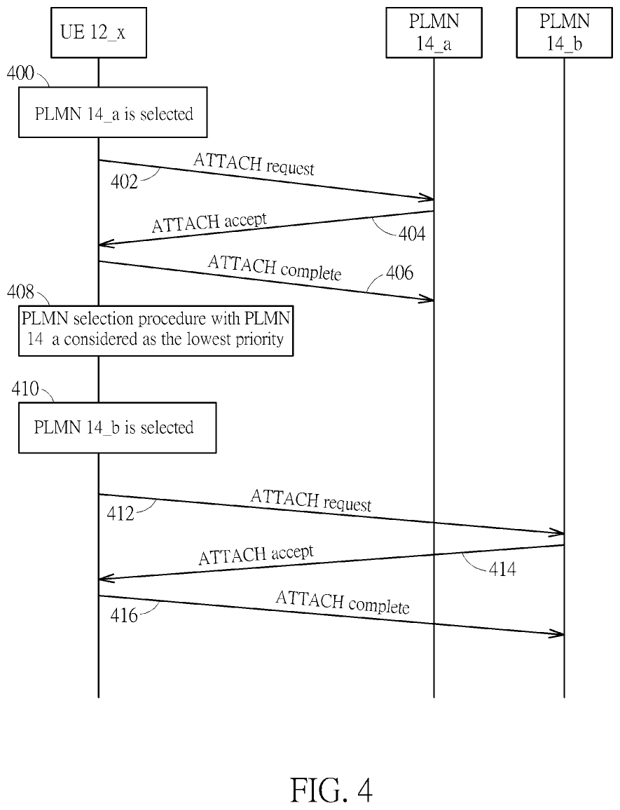

The aforementioned example can be combined with the example in FIG. 1, and explained in detail through FIG. 4. As shown in FIG. 4, a UE 12_x of the wireless communication system 10 has selected a PLMN 14_a (Step 400) and initiates an ATTACH procedure by sending an ATTACH request message to the PLMN 14_a (Step 402), wherein the UE 12_x supports ePCO and intends to have non-IP, Ethernet PDN type, or UAS service, while the PLMN 14_a does not support ePCO. According to the ATTACH request message, the PLMN 14_a accepts the request and returns an ATTACH accept message (Step 404). Since the PLMN 14_a does not support ePCO, the ePCO bit in the EPS network feature support IE in the ATTACH accept message is not set to “extended protocol configuration options supported”, meaning that the PLMN 14_a does not support ePCO. Then, the UE 12_x sends an ATTACH complete message to complete the ATTACH procedure (Step 406), and performs a PLMN selection procedure with the PLMN 14_a considered as the lowest priority (Step 408) according to the process 30. Since the PLMN 14_a is considered as the lowest priority, the UE 12_x does not select the PLMN 14_a. Instead, the UE 12_x selects a PLMN 14_b (Step 410) for another ATTACH procedure (Step 412 to Step 416). If the PLMN 14_b supports ePCO, the UE 12_x may have the non-IP, Ethernet PDN type, or UAS service with the PLMN 14_b after attaching to the PLMN 14_b.

In another example, the UE supports ePCO in a 5G NSA network, and the service required by the UE is non-IP, Ethernet PDN type, or UAS service, while the first PLMN has one or more MMEs supporting ePCO and one or more MMEs not supporting ePCO. The registration procedure may be a TAU procedure, and the acknowledgement message may be a TAU accept message of the TAU procedure. For example, the UE may register with an MME supporting ePCO and move to an area served by a new MME not supporting ePCO in the first PLMN. The UE may intend to have non-IP, Ethernet PDN type, or UAS service after moving to the area, and accordingly initiate a TAU procedure to inform the new MME of its new location. Since the new MME of the first PLMN does not support ePCO, an ePCO bit in an EPS network feature support IE in the TAU accept message is not set to “extended protocol configuration options supported.” Therefore, after the UE receives the TAU accept message from (the new MME of) the first PLMN, the UE knows that the first PLMN does not support ePCO and cannot provide the service required by the UE, such that the UE performs a PLMN selection procedure with the first PLMN considered as the lowest priority after completion of the TAU procedure according to the process 30. As a result, the UE would not stay in the first PLMN after the PLMN selection procedure, and may select a second PLMN which may support the service required by the UE.

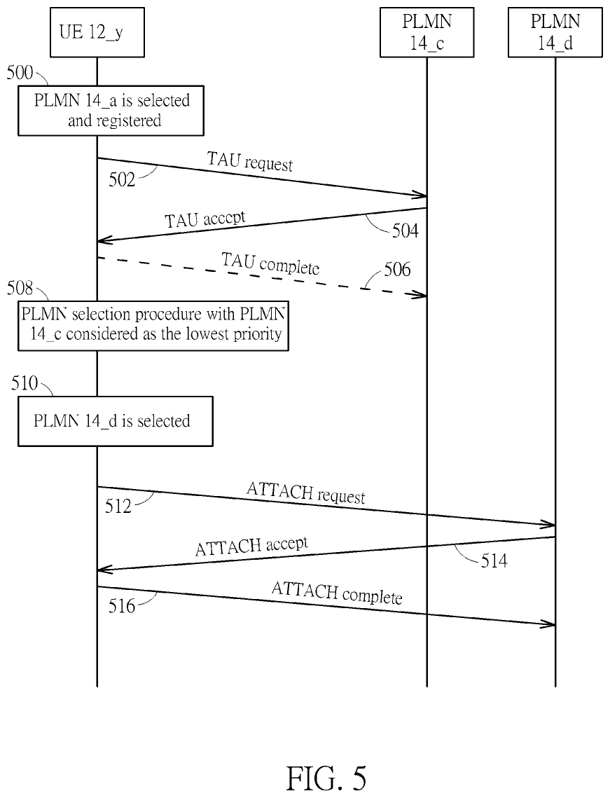

The aforementioned example can be combined with the example in FIG. 1, and explained in detail through FIG. 5. As shown in FIG. 5, a UE 12_y of the wireless communication system 10 has selected and registered with a first MME of a PLMN 14_c and moves to an area served by a second MME of the PLMN 14_c (Step 500), wherein the first MME supports ePCO and the second MME does not support ePCO. The UE 12_y supports ePCO and intends to have non-IP, Ethernet PDN type, or UAS service in the area served by the second MME. Thus, the UE 12_y initiates a TAU procedure to inform the second MME of its new location by sending a TAU request message to the second MME of the PLMN 14_c (Step 502). According to the TAU request message, the second MME of the PLMN 14_c returns a TAU accept message (Step 504). Since the second MME of the PLMN 14_c does not support ePCO, the ePCO bit in the EPS network feature support IE in the TAU accept message is not set to “extended protocol configuration options supported”, meaning that the PLMN 14_c does not support ePCO. Then, the UE 12_y completes the TAU procedure (by sending or not sending a TAU complete message to the PLMN 14_c (Step 506)), and performs a PLMN selection procedure with the PLMN 14_c considered as the lowest priority (Step 508) according to the process 30. Since the PLMN 14_c is considered as the lowest priority, the UE 12_y does not select the PLMN 14_c. Instead, the UE 12_y selects a PLMN 14_d (Step 510) for another ATTACH procedure (Step 512 to Step 516). If the PLMN 14_d supports ePCO, the UE 12_y may have the non-IP, Ethernet PDN type, or UAS service with the PLMN 14_d after attaching to the PLMN 14_d.

Note that, realization of the process 30 is not limited to the above description. Those skilled in the art should readily make combinations, modifications and/or alterations on the abovementioned description and examples. For example, according to the process 30, the UE considers the first PLMN, which does not support the service required by the UE, as having the lowest priority. In an example, the UE may further prioritize the first PLMN with the lowest priority. Methods for prioritizing the first PLMN with the lowest priority are not limited to any steps. For example, the UE may set priority of the first PLMN by managing at least a parameter corresponding to the first PLMN in a Universal Subscriber Identity Module (USIM). For example, the parameter may be, but not limited to, a “User Controlled PLMN with Access Technology” parameter EF_PLMNwACT, which is utilized to set the preferred PLMNs in priority order.

In another example, considering or prioritizing the first PLMN with the lowest priority involves determining the first PLMN as having the lowest priority. In other words, Step 304 may be replaced by Step 304′ as follows:

Step 304′: In response to the acknowledgement message indicating that the first PLMN does not support a service required by the UE, perform a PLMN selection procedure with the first PLMN determined as a lowest priority after completion of the registration procedure.

The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20.

Examples of the hardware may include analog circuit(s), digital circuit(s) and/or mixed circuit(s). For example, the hardware may include ASIC(s), field programmable gate array(s) (FPGA(s)), programmable logic device(s), coupled hardware components or combination thereof. In another example, the hardware may include general-purpose processor(s), microprocessor(s), controller(s), digital signal processor(s) (DSP(s)) or combination thereof.

Examples of the software may include set(s) of codes, set(s) of instructions and/or set(s) of functions retained (e.g., stored) in a storage unit, e.g., a computer-readable medium. The computer-readable medium may include SIM, ROM, flash memory, RAM, CD-ROM/DVD-ROM/BD-ROM, magnetic tape, hard disk, optical data storage device, non-volatile storage unit, or combination thereof. The computer-readable medium (e.g., storage unit) may be coupled to at least one processor internally (e.g., integrated) or externally (e.g., separated). The at least one processor which may include one or more modules may (e.g., be configured to) execute the software in the computer-readable medium. The set(s) of codes, the set(s) of instructions and/or the set(s) of functions may cause the at least one processor, the module(s), the hardware and/or the electronic system to perform the related steps.

Examples of the electronic system may include a system on chip (SoC), system in package (SiP), a computer on module (COM), a computer program product, an apparatus, a mobile phone, a laptop, a tablet computer, an electronic book or a portable computer system, and the communication device 20.

To sum up, the present invention provides a communication device and method for handling insufficient network supportability. When the acknowledgement message corresponding to the registration procedure received from the first PLMN indicates that the first PLMN does not support the service required by the communication device, the communication device and method perform a PLMN selection procedure with the first PLMN considered as a lowest priority after completion of the registration procedure. Thus, the communication device may select the second PLMN which may support the service required by the communication device, such that the communication device may be served for the required service by the second PLMN. The issue of insufficient network supportability is, therefore, overcome.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication method for handling insufficient network supportability in a user equipment (UE), wherein the UE has selected a first public land mobile network (PLMN) and initiates a registration procedure with the first PLMN, the method comprising:
receiving an acknowledgement message corresponding to the registration procedure from the first PLMN; and
in response to the acknowledgement message indicating that the first PLMN does not support a service required by the UE, performing a PLMN selection procedure with the first PLMN considered as a lowest priority after completion of the registration procedure.

2. The communication method of claim 1, wherein the registration procedure is an attach procedure, and the acknowledgement message is an attach accept message of the attach procedure.

3. The communication method of claim 2, wherein an extended Protocol Configuration Options (ePCO) bit in an Evolved Packet System (EPS) network feature support Information Element (IE) in the attach accept message is not set to “extended protocol configuration options supported” to indicate that the first PLMN does not support the service required by the UE.

4. The communication method of claim 1, wherein the registration procedure is a tracking area updating procedure, and the acknowledgement message is a tracking area update accept message of the tracking area updating procedure.

5. The communication method of claim 4, wherein an extended Protocol Configuration Options (ePCO) bit in an Evolved Packet System (EPS) network feature support Information Element (IE) in the tracking area update accept message is not set to “extended protocol configuration options supported” to indicate that the first PLMN does not support the service required by the UE.

6. The communication method of claim 1, wherein the service required by the UE is one or more of: non-Internet Protocol (non-IP), Ethernet Packet Data Network type, and Unmanned Aerial Systems (UAS) services.

7. The communication method of claim 1, further comprising prioritizing the first PLMN with the lowest priority.

8. A communication device for handling insufficient network supportability, wherein the communication device has selected a first public land mobile network (PLMN) and initiates a registration procedure with the first PLMN, the communication device comprising:
a storage device; and
a processing circuit, coupled to the storage device, wherein the processing circuit receives an acknowledgement message corresponding to the registration procedure from the first PLMN; and in response to the acknowledgement message indicating that the first PLMN does not support a service required by the communication device, performs a PLMN selection procedure with the first PLMN considered as a lowest priority after completion of the registration procedure.

9. The communication device of claim 8, wherein the registration procedure is an attach procedure, and the acknowledgement message is an attach accept message of the attach procedure.

10. The communication device of claim 9, wherein an extended Protocol Configuration Options (ePCO) bit in an Evolved Packet System (EPS) network feature support Information Element (IE) in the attach accept message is not set to “extended protocol configuration options supported” to indicate that the first PLMN does not support the service required by the UE.

11. The communication device of claim 8, wherein the registration procedure is a tracking area updating procedure, and the acknowledgement message is a tracking area update accept message of the tracking area updating procedure.

12. The communication device of claim 11, wherein an extended Protocol Configuration Options (ePCO) bit in an Evolved Packet System (EPS) network feature support Information Element (IE) in the tracking area update accept message is not set to “extended protocol configuration options supported” to indicate that the first PLMN does not support the service required by the UE.

13. The communication device of claim 1, wherein the service required by the UE is one or more of: non-Internet Protocol (non-IP), Ethernet Packet Data Network type, and Unmanned Aerial Systems (UAS) services.

14. The communication device of claim 1, wherein the instructions further comprise prioritizing the first PLMN with the lowest priority.

15. A communication method for handling insufficient network supportability in a user equipment (UE), wherein the UE has selected a first public land mobile network (PLMN) and initiates a registration procedure with the first PLMN, the method comprising:
receiving an acknowledgement message corresponding to the registration procedure from the first PLMN; and
in response to the acknowledgement message indicating that the first PLMN does not support a service required by the UE, performing a PLMN selection procedure with the first PLMN determined as a lowest priority after completion of the registration procedure.

16. A communication device for handling insufficient network supportability, wherein the communication device has selected a first public land mobile network (PLMN) and initiates a registration procedure with the first PLMN, the communication device comprising:
a storage device; and
a processing circuit, coupled to the storage device, wherein the processing circuit receives an acknowledgement message corresponding to the registration procedure from the first PLMN; and in response to the acknowledgement message indicating that the first PLMN does not support a service required by the communication device, performs a PLMN selection procedure with the first PLMN determined as a lowest priority after completion of the registration procedure.
